(19) United States
(12) Patent Application Publication
(10) Pub. No.: US 2018/0319279 A1
(43) Pub. Date: Nov. 8, 2018

(54) ON-VEHICLE APPARATUS, DROWSY DRIVING PREVENTION METHOD, AND COMPUTER READABLE MEDIUM

(71) Applicant: MITSUBISHI ELECTRIC CORPORATION, Tokyo (JP)

(72) Inventors: Kumiko IKEDA, Tokyo (JP); Mitsuo SHIMOTANI, Tokyo (JP); Mengxiong WANG, Tokyo (JP); Akihiro MIMURA, Tokyo (JP)

(73) Assignee: MITSUBISHI ELECTRIC CORPORATION, Tokyo (JP)

(21) Appl. No.: 15/774,144

(22) PCT Filed: Mar. 16, 2016
(86) PCT No.: PCT/JP2016/058327

§ 371 Date: May 7, 2018

(51) Int. Cl. B60K 28/02; G06K 9/00; B60W 10/30; G01C 21/34; G08B 21/06; B60W 10/18

(52) U.S. Cl. CPC B60K 28/02; G06K 9/00845; B60W 10/30; B60W 2720/10; G01C 21/3453; G08B 21/06; B60W 10/18; G01C 21/3415

(57) ABSTRACT

A passenger state determining unit (12) determines whether a passenger is sleeping, the passenger being a person riding in a vehicle other than a driver. An operation performing unit (20) performs drowsiness prevention operation for preventing the driver from feeling drowsy, when it is determined by the passenger state determining unit (12) that the passenger is sleeping.

### TECHNICAL FIELD

The present invention relates to a technique for preventing drowsy driving.

### BACKGROUND ART

To prevent an accident caused by a driver dozing off, there is a technique in which sensors are attached in a vehicle and it is detected whether a driver feels drowsy, using the sensors (e.g., Patent Literature 1).

### CITATION LIST

### Patent Literature

Patent Literature 1: JP 2010-134533 A

### SUMMARY OF INVENTION

### Technical Problem

In the technique of Patent Literature 1, it is detected whether the driver feels drowsy, using the sensors and when the driver feels drowsy, operation for waking up the driver is performed. However, in the technique of Patent Literature 1, since operation for waking up the driver starts after the driver feels drowsy, it takes time for the driver to completely wake up. During a period before the driver completely wakes up, the driver is driving with a lack of attention.

As described above, in the technique of Patent Literature 1, since operation for waking up the driver starts after the driver feels drowsy, a period of time during which the driver is driving with a lack of attention is long, and thus, there is a problem of insufficient safety.

The main object of the present invention is to solve problems such as that described above, and the main object of the present invention is to prevent the driver from feeling drowsy.

### Solution to Problem

An on-vehicle apparatus mounted on a vehicle, includes:

a passenger state determining unit to determine whether a passenger is sleeping, the passenger being a person riding in the vehicle other than a driver; and

an operation performing unit to perform drowsiness prevention operation for preventing the driver from feeling drowsy, when it is determined by the passenger state determining unit that the passenger is sleeping.

### Advantageous Effects of Invention

According to the present invention, drowsiness prevention operation is performed before the driver feels drowsy affected by the passenger, and thus, the driver can continue driving without feeling drowsy.

### BRIEF DESCRIPTION OF DRAWINGS

FIG. 1 is a diagram illustrating an exemplary functional configuration of an on-vehicle apparatus according to a first embodiment.

FIG. 2 is a flowchart diagram illustrating an exemplary process of a control unit according to the first embodiment.

FIG. 3 is a diagram illustrating an example of operation information according to the first embodiment.

FIG. 4 is a diagram illustrating an exemplary hardware configuration of the on-vehicle apparatus according to the first embodiment.

FIG. 5 is a diagram illustrating an exemplary functional configuration of an on-vehicle apparatus according to a second embodiment.

FIG. 6 is a flowchart diagram illustrating an exemplary process of a control unit according to the second embodiment.

FIG. 7 is a diagram illustrating an exemplary functional configuration of an on-vehicle apparatus according to a third embodiment.

FIG. 8 is a flowchart diagram illustrating an exemplary process of a control unit according to the third embodiment.

### DESCRIPTION OF EMBODIMENTS

### First Embodiment

### Description of Configuration

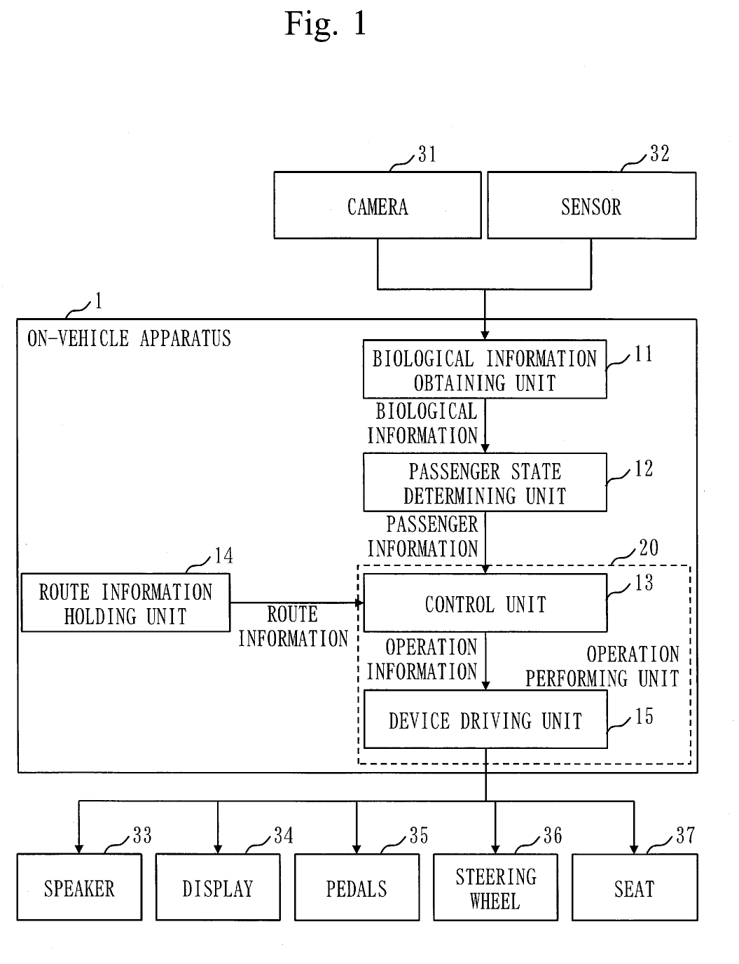

FIG. 1 illustrates an exemplary functional configuration of an on-vehicle apparatus 1 according to the present embodiment.

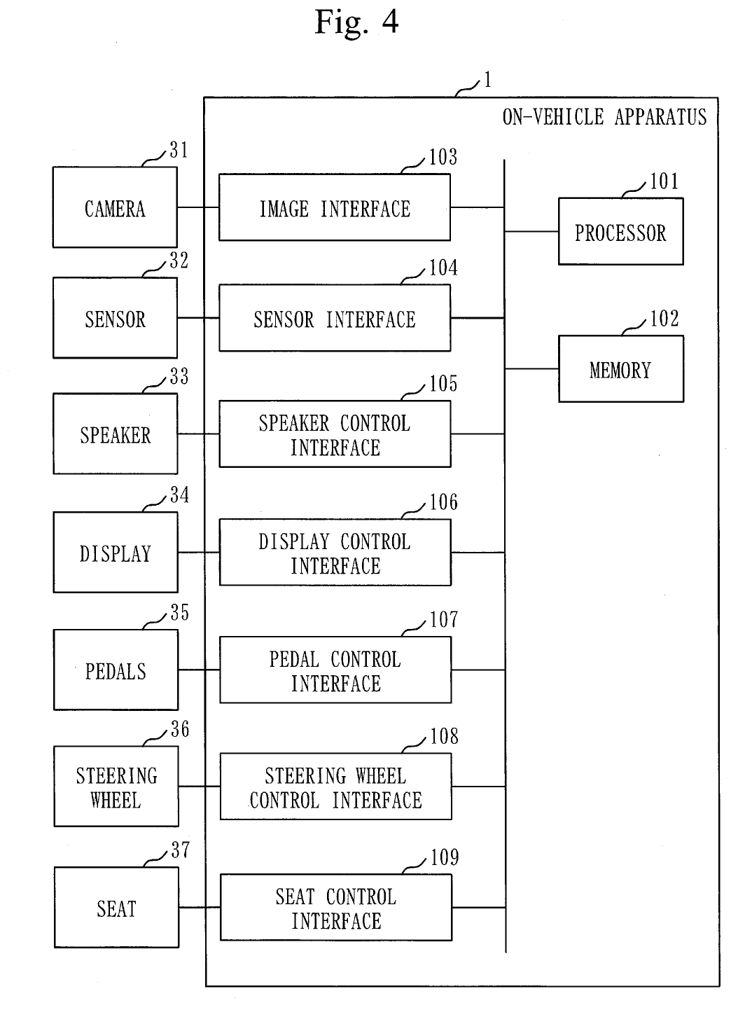

In addition, FIG. 4 illustrates an exemplary hardware configuration of the on-vehicle apparatus 1 according to the present embodiment.

It is assumed that the on-vehicle apparatus 1 is mounted on a vehicle which is not illustrated.

Note that operation performed by the on-vehicle apparatus 1 is an example of a drowsy driving prevention method and a drowsy driving prevention program.

First, with reference to FIG. 4, a hardware configuration of the on-vehicle apparatus 1 will be described.

As illustrates in FIG. 4, the on-vehicle apparatus 1 is a computer including a processor 101, a memory 102, an image interface 103, a sensor interface 104, a speaker control interface 105, a display control interface 106, a pedal control interface 107, a steering wheel control interface 108, and a seat control interface 109.

The processor 101 executes a program that realizes a biological information obtaining unit 11, a passenger state determining unit 12, and an operation performing unit 20 (a control unit 13 and a device driving unit 15) which are illustrated in FIG. 1. That is, the biological information obtaining unit 11, the passenger state determining unit 12, and the operation performing unit 20 are realized by the program.

The program that realizes the biological information obtaining unit 11, the passenger state determining unit 12, and the operation performing unit 20 is stored in the memory 102. The processor 101 loads the program that realizes the biological information obtaining unit 11, the passenger state determining unit 12, and the operation performing unit 20 from the memory 102 and executes the program.

In addition, the memory 102 realizes a route information holding unit 14 illustrated in FIG. 1.

In addition, the on-vehicle apparatus 1 is connected to a camera 31 through the image interface 103.

The image interface 103 is a circuit that obtains a photographed image from the camera 31 and transfers the obtained photographed image to the processor 101.

In addition, the on-vehicle apparatus 1 is connected to a sensor 32 through the sensor interface 104.

The sensor interface 104 is a circuit that obtains sensor data from the sensor 32 and transfers the obtained sensor data to the processor 101.

In addition, the on-vehicle apparatus 1 is connected to a speaker 33 through the speaker control interface 105.

The speaker control interface 105 is a circuit that controls the speaker 33 according to an instruction from the processor 101.

In addition, the on-vehicle apparatus 1 is connected to a display 34 through the display control interface 106.

The display control interface 106 is a circuit that controls the display 34 according to an instruction from the processor 101.

In addition, the on-vehicle apparatus 1 is connected to pedals 35 through the pedal control interface 107.

The pedal control interface 107 is a circuit that controls the pedals 35 according to an instruction from the processor 101. Note that the pedals 35 include an accelerator pedal and a brake pedal.

In addition, the on-vehicle apparatus 1 is connected to a steering wheel 36 through the steering wheel control interface 108.

The steering wheel control interface 108 is a circuit that controls the steering wheel 36 according to an instruction from the processor 101. Note that a vibrator that generates vibrations is built in the steering wheel 36.

In addition, the on-vehicle apparatus 1 is connected to a seat 37 through the seat control interface 109.

The seat control interface 109 is a circuit that controls the seat 37 according to an instruction from the processor 101. Note that a vibrator that generates vibrations is built in the seat 37.

Note that in the following the speaker 33, the display 34, the pedals 35, the steering wheel 36, and the seat 37 are also collectively referred to as devices.

Next, with reference to FIG. 1, a functional configuration of the on-vehicle apparatus 1 will be described.

The biological information obtaining unit 11 obtains a photographed image from the camera 31 through the image interface 103 of FIG. 4. The camera 31 is disposed in a position in which the camera 31 can photograph the face of a passenger in the vehicle, and the biological information obtaining unit 11 obtains an image in which the passenger's face is photographed (hereinafter, referred to as face image) from the camera 31. The camera 31 performs image analysis to detect the positions of the passenger's eyes and mouth and detect the orientation of the passenger's face. Note that the passenger is a person riding in the vehicle other than a driver.

Furthermore, the biological information obtaining unit 11 obtains sensor data from the sensor 32 through the sensor interface 104 of FIG. 4. The sensor 32 measures passenger's body temperature or/and measures passenger's respiratory rate. As the sensor 32 that measures body temperature, an infrared camera is considered to be used. In addition, as the sensor 32 that measures body temperature, a temperature sensor attached to a seat is considered to be used. In addition, as the sensor 32 that measures respiratory rate, a radio frequency (RF) sensor is considered to be used. That is, the RF sensor observes passenger's chest movements and measures respiratory rate. In addition, the camera 31 may photograph passenger's body movements and measure respiratory rate.

Note that the photographed image and sensor data obtained by the biological information obtaining unit 11 are referred to as biological information. The biological information obtaining unit 11 transmits the obtained biological information to the passenger state determining unit 12.

The passenger state determining unit 12 obtains the biological information from the biological information obtaining unit 11. Then, the passenger state determining unit 12 analyzes the biological information to determine whether the passenger is sleeping.

The passenger state determining unit 12, for example, extracts an image of eyes from the face image of the passenger and performs image analysis on the image of eyes. Then, the passenger state determining unit 12 analyzes whether the image of eyes show pupils, to determine whether the passenger is in an eyes-open state or an eyes-closed state. Then, when the passenger is closing his/her eyes continuously for a certain period of time or more, the passenger state determining unit 12 determines that the passenger is sleeping.

In addition, the passenger state determining unit 12 determines whether the passenger's body temperature has increased by a threshold value or more (e.g., 1° C. or more), using the sensor data obtained by the measurement of body temperature by the sensor 32. When the passenger's body temperature has increased by the threshold value or more, the passenger state determining unit 12 determines that the passenger is sleeping.

In addition, the passenger state determining unit 12 determines whether the average value of passenger's respiratory rate is reduced continuously for a certain period by a threshold value or more, using the sensor data obtained by the measurement of respiratory rate by the sensor 32. Then, when the average value of passenger's respiratory rate is reduced by the threshold value or more, the passenger state determining unit 12 determines that the passenger is sleeping.

The passenger state determining unit 12 may determine whether the passenger is sleeping, by combining those determination techniques. In addition, the passenger state determining unit 12 may use determination techniques other than the above-described determination techniques.

The passenger state determining unit 12 transmits a determination result as passenger information to the control unit 13.

Note that a process performed by the passenger state determining unit 12 corresponds to a passenger state determination process.

The route information holding unit 14 holds route information illustrating a travel route to a vehicle's destination.

The route information holding unit 14 transmits the route information to the control unit 13 in response to a request from the control unit 13.

The control unit 13 obtains the passenger information from the passenger state determining unit 12. Then, when the passenger information gives notice that the passenger is sleeping, the control unit 13 transmits operation information to the device driving unit 15. When the passenger is sleeping, the driver is also expected to feel drowsy later on, and thus, the control unit 13 transmits operation information to the device driving unit 15 to perform drowsiness prevention operation for preventing the driver from feeling drowsy.

In the operation information is described drowsiness prevention operation to be performed by the device driving unit 15.

The control unit 13 instructs the device driving unit 15 to, for example, move contact parts with which the driver is in contact among vehicle's parts, as drowsiness prevention operation. The contact parts are, for example, the pedals 35, the steering wheel 36, and the seat 37.

In addition, the control unit 13 instructs the device driving unit 15 to, for example, output audio from the speaker 33, as drowsiness prevention operation.

In addition, the control unit 13 instructs the device driving unit 15 to, for example, output a message from the display 34, as drowsiness prevention operation.

The device driving unit 15 obtains the operation information from the control unit 13 and performs drowsiness prevention operation by controlling devices according to the operation information.

As described above, the device driving unit 15 moves, for example, the pedals 35, the steering wheel 36, and the seat 37 which are contact parts.

In addition, the device driving unit 15 causes the speaker 33 to output audio.

In addition, the device driving unit 15 causes the display 34 to output a message.

Note that the control unit 13 and the device driving unit 15 are collectively referred to as the operation performing unit 20. In addition, processes performed by the control unit 13 and the device driving unit 15 correspond to an operation performance process.

### Description of Operation

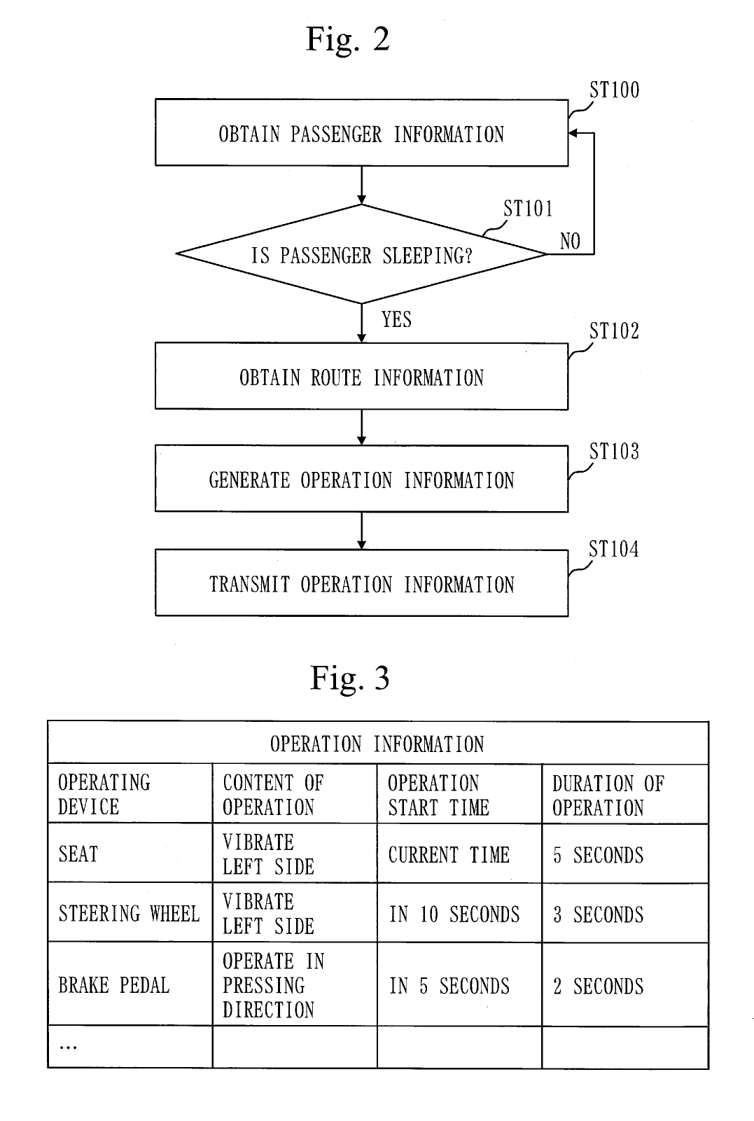

FIG. 2 is a flowchart illustrating an exemplary process of the control unit 13. With reference to FIG. 2, the process of the control unit 13 will be described. Note that in the following an example will be described in which the control unit 13 performs navigation by moving contact parts as drowsiness prevention operation.

The control unit 13 first obtains passenger information from the passenger state determining unit 12 (step ST100).

Then, the control unit 13 analyzes the passenger information to determine whether the passenger is sleeping (step ST101).

If it is determined that the passenger is sleeping, the control unit 13 obtains route information from the route information holding unit 14 (step ST102). On the other hand, if it is determined that the passenger is not sleeping, step ST100 is repeated.

Then, the control unit 13 generates operation information based on the route information obtained at step ST102 (step ST103).

Here, an example will be described in which navigation is performed by moving the seat 37, the steering wheel 36, and the pedals 35, as drowsiness prevention operation.

The control unit 13 identifies a turning point which is a point at which the vehicle makes a right turn or a left turn, based on the route information obtained at step ST102. Then, the control unit 13 generates operation information that instructs the device driving unit 15 to vibrate the seat 37 of the driver when the vehicle reaches an arbitrary point before the turning point (e.g., 100 m before the turning point). More specifically, if the vehicle makes a right turn at the turning point, the control unit 13 generates operation information that instructs the device driving unit 15 to vibrate the right side of the seat 37 of the driver. In addition, if the vehicle makes a left turn at the turning point, operation information that instructs the device driving unit 15 to vibrate the left side of the seat of the driver is generated.

In addition, the control unit 13 generates operation information that instructs the device driving unit 15 to vibrate the steering wheel 36 of the vehicle when the vehicle reaches the turning point. More specifically, when the vehicle makes a right turn at the turning point, the control unit 13 generates operation information that instructs the device driving unit 15 to vibrate the right side of the steering wheel 36. In addition, when the vehicle makes a left turn at the turning point, operation information that instructs the device driving unit 15 to vibrate the left side of the steering wheel 36 is generated.

In addition, the control unit 13 generates operation information that instructs the device driving unit 15 to move the brake pedal of the vehicle in a pressing direction when the vehicle reaches an arbitrary point before the turning point (e.g., 100 m before the turning point).

In addition, the control unit 13 generates operation information that instructs the device driving unit 15 to move the accelerator pedal of the vehicle in a push-back direction when the vehicle reaches an arbitrary point before the turning point (e.g., 100 m before the turning point).

Each operation information includes the name of a device to operate, the content of operation, operation start time, and duration of operation.

FIG. 3 illustrates an example of operation information. FIG. 3 illustrates operation information for when the vehicle makes a left turn at the turning point.

Note that the control unit 13 obtains vehicle speed of the vehicle from a vehicle speed sensor which is not illustrated in FIGS. 1 and 4 and obtains a vehicle's current location from a global positioning system (GPS system) which is not illustrated in FIGS. 1 and 4, to generate operation information of FIG. 3.

Then, referring back to FIG. 2, the control unit 13 transmits the operation information generated at step ST103 to the device driving unit 15 (step ST104).

The device driving unit 15 obtains the operation information from the control unit 13 and performs drowsiness prevention operation by controlling devices according to the operation information.

When the operation information of FIG. 3 is obtained, the device driving unit 15 vibrates the left side of the seat 37 by controlling the vibrator in the seat 37 at timing described in the operation information. In addition, the device driving unit 15 vibrates the left side of the steering wheel 36 by controlling the vibrator in the steering wheel 36 at timing described in the operation information. In addition, the device driving unit 15 moves the brake pedal in the pressing direction by controlling the brake pedal of the pedals 35 at timing described in the operation information.

In addition, the device driving unit 15 may display a message on the display 34 and output audio from the speaker 33, in accordance with the movements of the seat 37, the steering wheel 36, and the pedals 35.

In addition, the device driving unit 15 may change the volume of the speaker 33 to make navigation audio louder, instead of moving the seat 37, the steering wheel 36, and the pedals 35.

### Description of an Advantageous Effect of the Embodiment

As described above, in the present embodiment, when the passenger is sleeping, drowsiness prevention operation is performed before the driver feels drowsy affected by the passenger. Thus, the driver can continue driving without feeling drowsy.

### Second Embodiment

The above first embodiment describes an example in which, when the passenger is sleeping, navigation is performed by moving devices. In the present embodiment, an example in which, when the passenger is sleeping, a vehicle's travel route is changed will be described.

### Description of Configuration

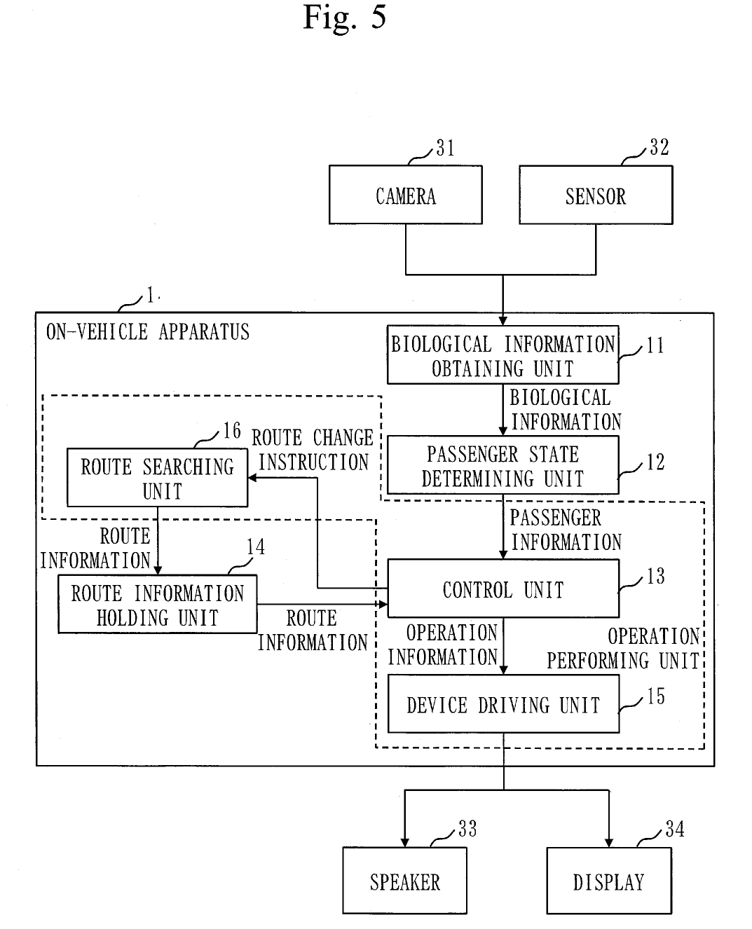

FIG. 5 illustrates an exemplary functional configuration of an on-vehicle apparatus 1 according to the present embodiment.

The same components as those of FIG. 1 are given the same reference signs.

In FIG. 5, a route searching unit 16 is added to the configuration illustrated in FIG. 1.

The route searching unit 16 searches for a travel route using map information, for a preset destination. Then, the route searching unit 16 stores route information illustrating the travel route obtained by the search, in the route information holding unit 14.

In addition, when the route searching unit 16 obtains a route change instruction from the control unit 13, the route searching unit 16 re-searches for a travel route according to the route change instruction. For example, the route searching unit 16 may receive an instruction from the control unit 13 to search for a travel route with many corners. In addition, the route searching unit 16 may receive an instruction to search for a travel route with many traffic lights. In addition, the route searching unit 16 may receive an instruction from the control unit 13 to search for a travel route by which the vehicle arrives at a destination faster. Furthermore, when the vehicle is traveling at night, the route searching unit 16 may receive an instruction from the control unit 13 to search for a travel route with bright street lights such as a highway.

When the route searching unit 16 has re-searched for a travel route, the route searching unit 16 stores route information illustrating a travel route obtained by the re-search, in the route information holding unit 14.

In the present embodiment, when a travel route to a vehicle's destination is set and navigation according to the travel route is performed, the control unit 13 sets, instead of the current travel route, a new travel route by which the driver feels less drowsy compared to the current travel route, as drowsiness prevention operation. Then, the control unit 13 causes the device driving unit 15 to perform navigation according to the new travel route.

That is, when the passenger is sleeping, the driver is also expected to feel drowsy later on, and thus, the control unit 13 changes the current travel route to a travel route by which the driver feels less drowsy.

For example, the control unit 13 changes a travel route to one with many traffic lights to increase the number of brake operations for stopping at the traffic lights, and thereby makes the driver feel less drowsy. In addition, the control unit 13 changes a travel route to one with many corners to increase the numbers of steering wheel operations and brake operations, and thereby makes the driver feel less drowsy. In addition, when the vehicle is traveling at night, the control unit 13 changes a travel route to one with bright street lights such as a highway, and thereby makes the driver feel less drowsy compared to traveling a dark road.

In addition, the control unit 13 may change a travel route to a travel route by which the vehicle arrives at a destination faster.

Furthermore, when the destination is far away, the control unit 13 may change a travel route to a travel route including a location where the driver can take a break, such as a service area.

Note also that the control unit 13 may ask the driver whether to change a travel route, before changing the travel route.

The control unit 13 instructs the route searching unit 16 to search for a new travel route, and causes the device driving unit 15 to perform navigation according to the new travel route obtained by the search performed by the route searching unit 16.

The device driving unit 15 performs navigation according to the new travel route specified by the control unit 13.

Note that, in the present embodiment, the control unit 13, the device driving unit 15, and the route searching unit 16 form the operation performing unit 20.

In addition, components other than the control unit 13, the device driving unit 15, and the route searching unit 16 are the same as those illustrated in FIG. 1, and thus, description thereof is omitted.

An exemplary hardware configuration of the on-vehicle apparatus 1 according to the present embodiment is as illustrated in FIG. 4. Note that in the present embodiment it is assumed that the processor 101 executes a program that realizes the route searching unit 16 and performs a process of the route searching unit 16 illustrated below.

In the following, differences from the first embodiment will be mainly described. Matters that are not described below are the same as those of the first embodiment.

### Description of Operation

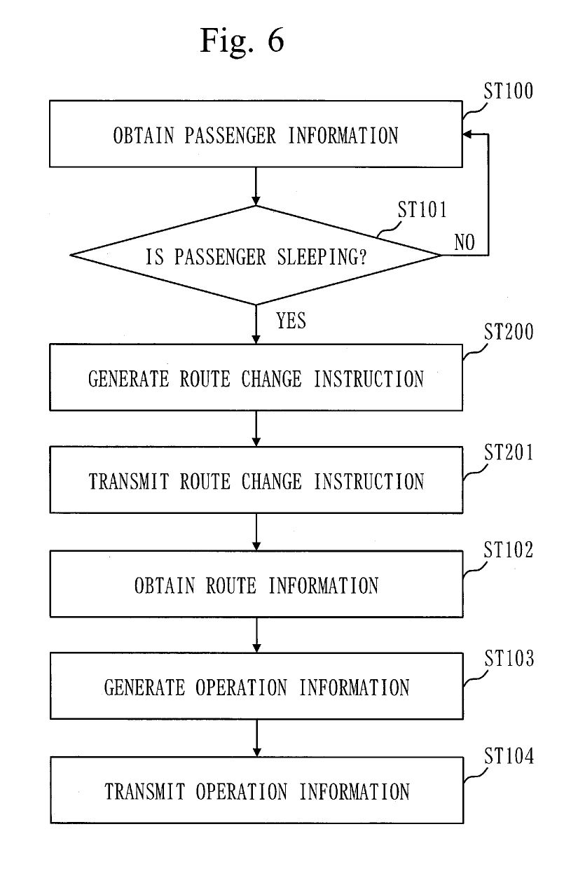

FIG. 6 is a flowchart illustrating an exemplary process of the control unit 13. With reference to FIG. 6, the operation of the control unit 13 will be described.

The control unit 13 first obtains passenger information from the passenger state determining unit 12 (step ST100).

Then, the control unit 13 analyzes the passenger information to determine whether the passenger is sleeping (step ST101).

If it is determined that the passenger is sleeping, the control unit 13 generates a route change instruction (step ST200). For example, the control unit 13 generates a route change instruction instructing to search for a new travel route with more traffic lights than the current travel route.

Then, the control unit 13 transmits the route change instruction to the route searching unit 16 (step ST201).

The route searching unit 16 re-searches for a travel route according to the route change instruction, and stores route information indicating a new travel route obtained by the re-search, in the route information holding unit 14.

Then, the control unit 13 obtains the route information indicating the new travel route obtained by the re-search by the route searching unit 16, from the route information holding unit 14 (step ST102).

Then, the control unit 13 generates operation information (step ST103).

Specifically, the control unit 13 generates operation information that instructs the device driving unit 15 to display the new travel route illustrated by the route information obtained at step ST102 on the display 34, and provide route guidance according to the new travel route.

Then, the control unit 13 transmits the operation information generated at step ST103 to the device driving unit 15 (step ST104).

Note that in a case in which the passenger has woken up when the device driving unit 15 is providing route guidance according to the new travel route, the control unit 13 may change the travel route back to the one used before the change. That is, the control unit 13 may transmit to the device driving unit 15 operation information that instructs the device driving unit 15 to provide route guidance according to the travel route used before the change.

### Description of an Advantageous Effect of the Embodiment

As described above, in the present embodiment, when the passenger is sleeping, a travel route is changed to one by which the driver feels less drowsy. Thus, the driver can continue driving without feeling drowsy.

### Third Embodiment

In the present embodiment, an example in which the driver is prevented from feeling drowsy by increasing opportunities to stop at traffic lights will be described.

### Description of Configuration

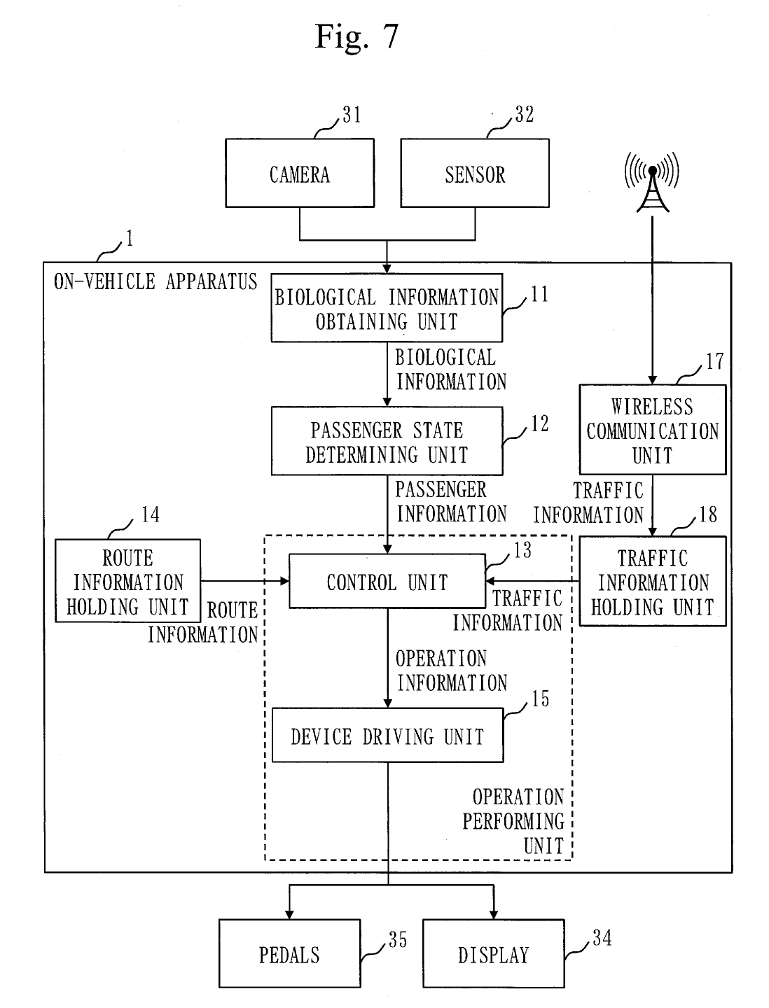

FIG. 7 illustrates an exemplary functional configuration of an on-vehicle apparatus 1 according to the present embodiment.

The same components as those of FIG. 1 are given the same reference signs.

In FIG. 7, a wireless communication unit 17 and a traffic information holding unit 18 are added to the configuration illustrated in FIG. 1.

The wireless communication unit 17 performs wireless communication with a base station outside the vehicle to obtain traffic information. The traffic information includes information about the switching timing of traffic lights (hereinafter, referred to as signal timing information). The wireless communication unit 17 stores the obtained traffic information in the traffic information holding unit 18.

The traffic information holding unit 18 holds the traffic information received by the wireless communication unit 17, and transmits the traffic information to the control unit 13 when the traffic information is requested by the control unit 13.

In the present embodiment, the control unit 13 obtains the traffic information from the traffic information holding unit 18. In addition, the control unit 13 calculates travel speed for causing the vehicle to stop at a traffic light from the traffic information, route information and vehicle's current location information, and causes the vehicle to travel at the calculated travel speed, as drowsiness prevention operation. That is, the control unit 13 calculates travel speed at which the vehicle reaches a traffic light through which the vehicle is to pass, during a time period during which the traffic light is “red”. The control unit 13 generates operation information that instructs the device driving unit 15 to travel at the thus calculated travel speed, and transmits the generated operation information to the device driving unit 15.

The device driving unit 15 performs control for causing the vehicle to travel at the travel speed instructed by the operation information. For example, the device driving unit 15 displays the travel speed instructed by the operation information on the display 34 as recommended travel speed. In addition, the device driving unit 15 causes the vehicle to travel at the travel speed instructed by the operation information, by controlling the accelerator pedal and the brake pedal.

Note that in the present embodiment, the control unit 13 and the device driving unit 15 form the operation performing unit 20.

In addition, components other than the control unit 13, the device driving unit 15, the wireless communication unit 17, and the traffic information holding unit 18 are the same as those illustrated in FIG. 1, and thus, description thereof is omitted.

An exemplary hardware configuration of the on-vehicle apparatus 1 according to the present embodiment is as illustrated in FIG. 4. Note that in the present embodiment it is assumed that the processor 101 executes a program that realizes the wireless communication unit 17 and performs a process of the wireless communication unit 17 described below. In addition, it is assumed that the memory 102 realizes the traffic information holding unit 18.

In the following, differences from the first embodiment will be mainly described. Matters that are not described below are the same as those of the first embodiment.

### Description of Operation

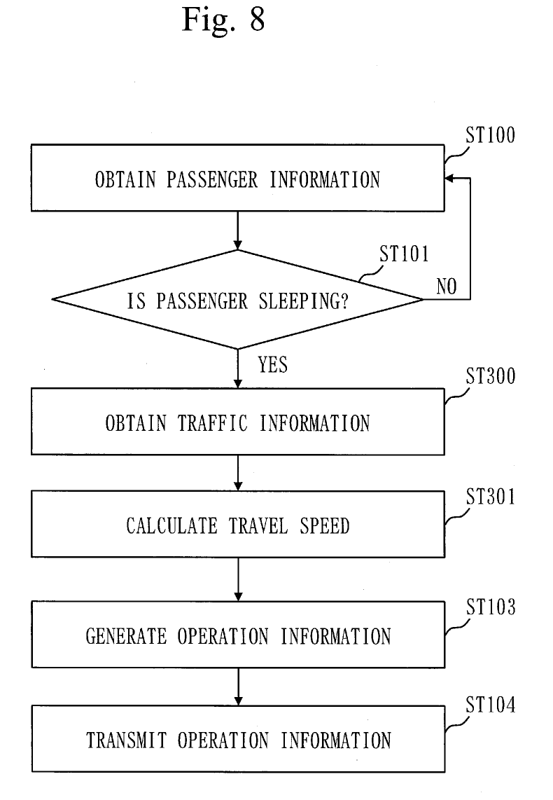

FIG. 8 is a flowchart illustrating the operation of the control unit of the on-vehicle apparatus 1. With reference to FIG. 8, the operation of the control unit 13 will be described.

The control unit 13 first obtains passenger information from the passenger state determining unit 12 (step ST100).

Then, the control unit 13 analyzes the passenger information to determine whether the passenger is sleeping (step ST101).

If it is determined that the passenger is sleeping, the control unit 13 obtains traffic information from the traffic information holding unit 18 (step ST300). In addition, the control unit 13 obtains route information from the route information holding unit 14, obtains a vehicle's current location from the GPS system, and obtains vehicle's current travel speed from the vehicle speed sensor.

Then, the control unit 13 calculates travel speed to be instructed to the device driving unit 15, from the obtained traffic information (step ST301). Namely, the control unit 13 calculates travel speed at which the vehicle is to stop at the next traffic light, using signal timing information included in the traffic information, the route information, the vehicle's current location, and the vehicle's current travel speed. For example, the control unit 13 identifies a traffic light through which the vehicle passes next in a travel route indicated by the route information. In addition, the control unit 13 calculates a reaching time at which the vehicle reaches the next traffic light, from the vehicle's current travel speed and the distance to the next traffic light. Then, if the next traffic light is “red” at the calculated reaching time, the control unit 13 decides to allow the vehicle to travel at the current travel speed without any change. In this case, the control unit 13 does not generate operation information. On the other hand, if the next traffic light is not “red” at the calculated reaching time, the control unit 13 calculates travel speed at which the vehicle can reach the next traffic light during a time period during which the next traffic light is “red”. That is, the control unit 13 finds a time period during which the next traffic light is “red” by referring to the signal timing information in the traffic information, and calculates travel speed at which the vehicle can reach the next traffic light during the time period during which the next traffic light is “red”, from the distance from the vehicle's current location to the next traffic light. Note that when the calculated travel speed is too fast or too slow for surrounding traffic conditions, the control unit 13 does not adopt the calculated travel speed. That is, the control unit 13 computes travel speed to cause the vehicle to stop at a traffic light after the next traffic light instead of at the next traffic light. Specifically, the control unit 13 calculates travel speed at which the vehicle reaches the traffic light after the next traffic light during a time period during which the traffic light is “red”.

Next, the control unit 13 generates operation information that gives notice of the calculated travel speed (step ST103).

Then, the control unit 13 transmits the generated operation information to the device driving unit 15 (step ST104).

The device driving unit 15, for example, displays the travel speed calculated by the control unit 13 on the display 34 as recommended speed, to prompt the driver to travel at the recommended speed.

In addition, the device driving unit 15 may cause the vehicle to travel at the travel speed calculated by the control unit 13, by controlling the accelerator pedal and the brake pedal. In this case, the device driving unit 15 may use, for example, a cruise control technique.

### Description of an Advantageous Effect of the Embodiment

As described above, in the present embodiment, when the passenger is sleeping, the vehicle is more often stopped at traffic lights, increasing driver's driving operation. Thus, the driver can continue driving without feeling drowsy.

### Fourth Embodiment

In the present embodiment, an example will be described in which, when the passenger is sleeping, an on-vehicle environment in which the driver is less likely to get drowsy is provided.

An exemplary functional configuration of an on-vehicle apparatus 1 according to the present embodiment is as illustrated in FIG. 1, and an exemplary hardware configuration is as illustrated in FIG. 4. In addition, an exemplary process of the control unit 13 according to the present embodiment is as illustrated in FIG. 2.

In the present embodiment, when the control unit 13 determines that the passenger is sleeping, the control unit 13 changes music played in the vehicle to music that makes the driver feel less drowsy. For example, the control unit 13 generates operation information that instructs the device driving unit 15 to change music to one that makes the driver feel uplifted, and transmits the generated operation information to the device driving unit 15.

The device driving unit 15 instructs an audio player to change music according to the operation information.

Note that the device driving unit 15 may perform control to change music and increase volume.

As described above, in the present embodiment, when the passenger is sleeping, the driver is made to feel uplifted, by which the driver can continue driving without feeling drowsy.

Although the embodiments of the present invention have been described above, two or more of the embodiments may be combined and implemented.

Alternatively, one of the embodiments may be partially implemented.

Alternatively, two or more of the embodiments may be partially combined and implemented.

Note that the present invention is not limited to the embodiments and various changes can be made as necessary.

### Description of Hardware Configuration

Finally, supplemental remarks on the hardware configuration of the on-vehicle apparatus 1 will be made.

The processor 101 illustrated in FIG. 4 is an integrated circuit (IC) that performs processing.

The processor 101 is a central processing unit (CPU), a digital signal processor (DSP), and the like.

The memory 102 illustrated in FIG. 4 is a random access memory (RAM), a flash memory, a hard disk drive (HDD), and the like.

The memory 102 also stores therein an operating system (OS).

Then, at least a part of the OS is executed by the processor 101.

The processor 101 executes a program that realizes the functions of the biological information obtaining unit 11, the passenger state determining unit 12, the control unit 13, the device driving unit 15, the route searching unit 16, the wireless communication unit 17, and the operation performing unit 20 (hereinafter, these are collectively referred to as “units”) while executing at least a part of the OS.

By the processor 101 executing the OS, task management, memory management, file management, communication control, and the like, are performed.

Although FIG. 4 illustrates one processor, the on-vehicle apparatus 1 may include a plurality of processors.

In addition, information, data, signal values, and variable values that illustrate processing results of the “units” are stored in the memory 102 or a register in the processor 101 or a cache memory.

In addition, the program that realizes the functions of the “units” may be stored in a portable storage medium such as a magnetic disk, a flexible disk, an optical disc, a compact disc, a Blu-ray (registered trademark) Disc, or a DVD.

In addition, the “units” may be read as “circuits” “steps”, “procedures”, or “processes”.

In addition, the on-vehicle apparatus 1 may be implemented by an electronic circuit such as a logic integrated circuit (IC), a gate array (GA), an application specific integrated circuit (ASIC), or a field-programmable gate array (FPGA).

In this case, the “units” each are implemented as a part of the electronic circuit.

Note that the processor and the above-described electronic circuit are also collectively referred to as processing circuitry.

### REFERENCE SIGNS LIST

1: on-vehicle apparatus, 11: biological information obtaining unit, 12: passenger state determining unit, 13: control unit, 14: route information holding unit, 15: device driving unit, 16: route searching unit, 17: wireless communication unit, 18: traffic information holding unit, 20: operation performing unit, 31: camera, 32: sensor, 33: speaker, 34: display, 35: pedals, 36: steering wheel, 37: seat, 101: processor, 102: memory, 103: image interface, 104: sensor interface, 105: speaker control interface, 106: display control interface, 107: pedal control interface, 108: steering wheel control interface, and 109: seat control interface

1-14. (canceled)

15. An on-vehicle apparatus mounted on a vehicle, the on-vehicle apparatus comprising:
processing circuitry to
determine whether a passenger is sleeping, the passenger being a person riding in the vehicle other than a driver; and
perform drowsiness prevention operation for preventing the driver from feeling drowsy, when it is determined that the passenger is sleeping.

16. The on-vehicle apparatus according to claim 15, wherein
the processing circuitry moves a contact part with which the driver is in contact among parts of the vehicle, as the drowsiness prevention operation.

17. The on-vehicle apparatus according to claim 16, wherein
the processing circuitry performs navigation by moving the contact part, as the drowsiness prevention operation.

18. The on-vehicle apparatus according to claim 16, wherein
the processing circuitry identifies a turning point being a point at which the vehicle makes a right turn or a left turn, and upon the vehicle reaching the turning point, as the drowsiness prevention operation, the processing circuitry vibrates a right side of a steering wheel of the vehicle being the contact part, when the vehicle makes a right turn at the turning point, and vibrates a left side of the steering wheel of the vehicle when the vehicle makes a left turn at the turning point.

19. The on-vehicle apparatus according to claim 16, wherein
the processing circuitry identifies a turning point being a point at which the vehicle makes a right turn or a left turn, and upon the vehicle reaching an arbitrary point before the turning point, the processing circuitry vibrates a seat of the driver of the vehicle being the contact part, as the drowsiness prevention operation.

20. The on-vehicle apparatus according to claim 19, wherein
the processing circuitry vibrates a right side of the seat of the driver when the vehicle makes a right turn at the turning point, and vibrates a left side of the seat of the driver when the vehicle makes a left turn at the turning point.

21. The on-vehicle apparatus according to claim 16, wherein
the processing circuitry identifies a turning point being a point at which the vehicle makes a right turn or a left turn, and upon the vehicle reaching an arbitrary point before the turning point, the processing circuitry moves an accelerator pedal of the vehicle being the contact part, in a push-back direction, as the drowsiness prevention operation.

22. The on-vehicle apparatus according to claim 16, wherein
the processing circuitry identifies a turning point being a point at which the vehicle makes a right turn or a left turn, and upon the vehicle reaching an arbitrary point before the turning point, the processing circuitry moves a brake pedal of the vehicle being the contact part, in a pressing direction, as the drowsiness prevention operation.

23. The on-vehicle apparatus according to claim 15, wherein
when a travel route to a destination of the vehicle is set and navigation according to the travel route is performed, the processing circuitry sets, instead of the travel route, a new travel route by which the driver feels less drowsy compared to the travel route and performs navigation according to the new travel route, as the drowsiness prevention operation.

24. The on-vehicle apparatus according to claim 23, wherein
the processing circuitry sets a route with at least one of more corners and more traffic lights compared to the travel route, as the new travel route.

25. The on-vehicle apparatus according to claim 15, wherein
the processing circuitry calculates travel speed for causing the vehicle to stop at a traffic light and causes the vehicle to travel at the calculated travel speed, as the drowsiness prevention operation.

26. The on-vehicle apparatus according to claim 15, wherein
the processing circuitry changes music played in the vehicle to music that makes the driver feel less drowsy, as the drowsiness prevention operation.

27. A drowsy driving prevention method performed on a vehicle, comprising:
determining whether a passenger is sleeping, the passenger being a person riding in the vehicle other than a driver; and
performing drowsiness prevention operation for preventing the driver from feeling drowsy, when it is determined that the passenger is sleeping.

28. A non-transitory computer readable medium storing a drowsy driving prevention program causing a computer mounted on a vehicle to execute:
a passenger state determination process to determine whether a passenger is sleeping, the passenger being a person riding in the vehicle other than a driver; and
an operation performance process to perform drowsiness prevention operation for preventing the driver from feeling drowsy, when it is determined by the passenger state determination process that the passenger is sleeping.
